(19) United States
(12) Patent Application Publication
(10) Pub. No.: US 2009/0024524 A1
(43) Pub. Date: Jan. 22, 2009

(54) OPTIMIZED RECHARGING OF PREPAID ACCOUNTS

(75) Inventors: Rudiger Hausmann, Penzberg (DE); Michael Horn, Munchen (DE); Peter Moritz, Haar (DE); Frank Perthel, Germering (DE)

Correspondence Address: BELL, BOYD & LLOYD, LLP, P.O. BOX 1135, CHICAGO, IL, 60690, US

(73) Assignee: Siemens Aktiengesellschaft, Muenchen (DE)

(21) Appl. No.: 12/100,214

(22) Filed: Apr. 9, 2008

Related U.S. Application Data
(63) Continuation of application No. 10/474,689, filed on Apr. 2, 2004, now abandoned.

(30) Foreign Application Priority Data
Apr. 12, 2001 (EP) 01109181.6
Aug. 6, 2001 (EP) 01118998.2

(51) Int. Cl. G06Q 40/00

(52) U.S. Cl. 705/41

(57) ABSTRACT

The invention relates to a method for recharging an electronic credit prepaid by a user, particularly for paying for services in a data or telecommunication system. The inventive method comprises the following steps: a) setting a lower account threshold value for the credit; b) signalling if the account falls below the threshold value; and c) triggering a recharging function if the value falls below the threshold value.

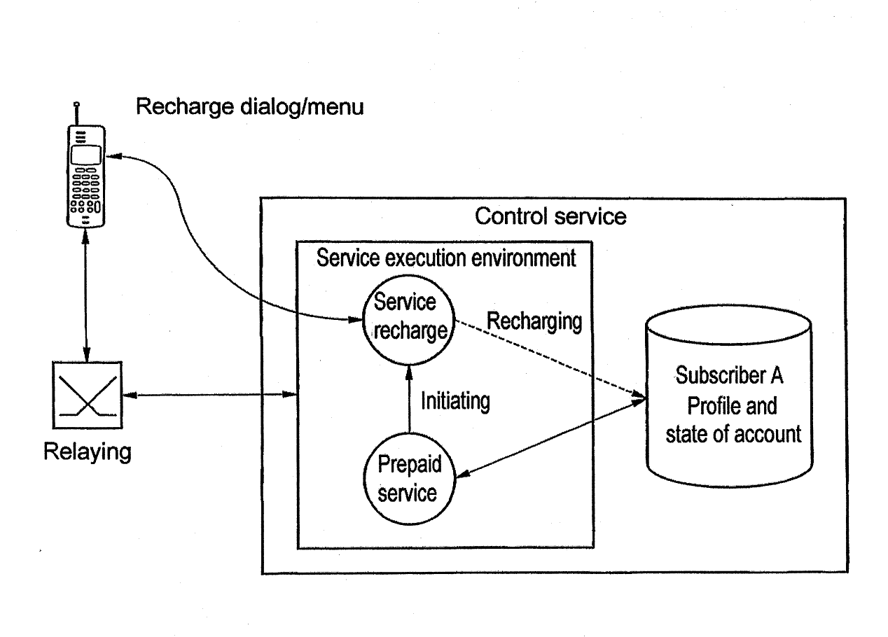

### CLAIM FOR PRIORITY

This application is a continuation of application Ser. No. 10/474,689, filed on Apr. 2, 2004, which claims priority to International Application No. PCT/EP02/03658 as published in the German language on Oct. 24, 2002.

### TECHNICAL FIELD OF THE INVENTION

The invention relates to a method for recharging an electronic prepaid credit that a user can adapt to suit specific needs.

### BACKGROUND OF THE INVENTION

Methods for recharging electronic credit prepaid by a user, particularly for payment of services in a data or telecommunication system, are known in the prior art and are usually dealt with by using payments by credit card, transfers, check or cash to service provider's account. The use of a prepaid service then usually takes place so that, for example, the mobile telephone of a user is initially registered by a caller line identification (CLI). The user is then called back by means of a callback on his or her mobile telephone. The user then makes the call by dialing, as normal, the required destination sub-scriber number or, for example, uses one of the speed dialing numbers registered with the service provider. By pressing the # key, the user can receive an announcement of the amount of credit remaining after the call.

Prepaid services of this kind are mainly offered to private customers, and in addition to favorable connection charges within Germany, also offer considerable savings for international calls depending on the destination country. The particular advantages of these services lie in the accounting being accurate to within seconds, the quarterly detailed individual call records, the simple access to subscriber number registrations (CLI) and being able to dial from any telephone using a personal account number and a PIN.

Despite the aforementioned advantages, service companies offering prepaid services are faced with not inconsiderable problems in this market segment. Thus, particularly in recent years, an attempt has been made to acquire wide categories of buyers as users of this service on the basis of using a mixed calculation from the proceeds from the sale of mobile telephones together with a prepaid usage credit. Particularly in the younger categories of buyers, offers of mobile telephones at an almost zero tariff together with prepaid services (prepaid cards) found wide acceptance.

Recently, it has been realized more and more that, due to the very low average level of prepaid credits, the cost basis of the operation of such an offer is questionable with regard to profitability or even covering costs in the short term. It is therefore meanwhile being considered whether to reconfigure the selling prices of mobile telephones so that at least part of the equipment costs are covered. On the other hand, the acceptance of prepaid services should be considerably improved by improved user operability, particularly simplified recharging of electronic credit. This should make a credit potential which is higher overall available to the service providers, to enable competitive service portfolios to be offered in the future.

### SUMMARY OF THE INVENTION

According to an aspect of the invention, a method is provided for recharging an electronic prepaid credit that the user can adapt in a simple self-explanatory manner to the user's specific needs.

The method according to this aspect includes setting a lower account threshold for the credit; signaling the undershooting of the threshold value; and triggering a recharging function if the threshold value is undershot.

According to another aspect of the invention, an automatic system is provided that can be set, e.g. as part of the contract for booking the services, and that frees the user from the decision to recharge the user's electronic credit. In this case, the lower account threshold value, or a number of account thresholds arranged in steps, can be set in such a way that a differentiated recharging of the credit account is also possible independent of the usage conditions.

According to a further aspect of the invention, a signal is preferably sent to the user and recharging is triggered by the user.

### BRIEF DESCRIPTION OF THE DRAWINGS

The method in accordance with the invention is described in more detail in the following with the aid of a drawing. This drawing is a functional diagram that explains the principle sequence of a recharging process of an electronic credit for payment of prepaid services.

### DETAILED DESCRIPTION OF THE PREFERRED EMBODIMENTS

A particular advantage of the invention is that the user is actively linked in to the recharging process and therefore can easily top off his electronic credit as desired. The user thereby has access to set the lower account threshold for the credit. The system behind this invention is based on the reversal of the function-calls-user sequence of actions to the user-calls-function sequence of actions. This reversal also enables the user, at the same time, to make extensive interventions with regard to the type and extent of the recharging of the user's electronic credit.

In a preferred manner, the recharging function is activated when the threshold value is undershot and is superimposed on the service currently being used by the user.

This enables the user to make a timely increase in the user's electronic credit, and thus ensure that the call is not cut off against the user's wishes, and possibly the connection blocked due to an inadequate credit level.

As an alternative, it is also possible that the charging function is placed in a waiting state in response to the threshold value being undershot, until the service currently being used by the user is completed. A function of this kind has the advantage that, for example, the current telephone call is not disturbed and instead the user receives a notice on completion to the effect that the user's minimum credit has been reached and requires recharging.

In a preferred manner, the recharging function can also automatically be repeatedly activated. If, for example, for a user with a prepaid credit of DM 100.00 a relatively high threshold value of DM 20.00 is set, an undershoot of this threshold value would not necessarily cause the connection to be blocked. The user could thus allow time for the recharging of the user's account because the automatic repeated activation of the recharging function would remind the user regularly, and also in increasing short intervals, of the necessity to top off the user's electronic credit.

If the recharging function remains active even if this is initially broken off or sometimes ignored by the user by triggering a cancel or ignore signal, it is ensured that the user would be given an adequate opportunity to match the user's prepaid credit to the services the user is using, before the connection is blocked.

In an advantageous embodiment, recharging repeatedly within a short time period by the method in accordance with an aspect of the invention is not possible. A recharging operation is then supported only within a specified time period (for example, one day). In the event of the mobile telephone being stolen or lost, the user has adequate time to have the user's account or mobile telephone blocked before greater financial damage occurs.

A particularly simple recharging of the electronic credit can be achieved in that the recharging function increases the credit by a fixed amount. The recharging by a fixed amount can, in this case, be triggered from the user end and also the system end. If, for example, the user has contractually agreed with the provider of the services a recharging of his credit by DM 20.00, in each case, when the bottom threshold value is reached, the user can top off the user's electronic credit simply by confirming the recharging function (Recharge ?—Yes/No).

A more flexible arrangement of the recharging can be achieved in that the recharging function increases the credit by an amount that can be set by the user. This can be advantageous in so far as a user can have selected a recharging amount on the first use of the booked services, that does not correspond to the actual utilization of the offer. If, for example, the user increasingly makes international calls, and at the same time makes more use of voice-mail functions (answer phone functions) and SMS (short message service), an increase in the recharging amount may be necessary.

This can naturally be accompanied by a retrospective change in the lower threshold value of the account at which the user receives notification. Where lower-value services are used, such as telephoning at a local rate, this could be DM 5.00, but where a wider service is more comprehensively utilized, such as Internet access, e-mail, SMS and voice mail, it could be substantially higher.

A particularly simple and flexible handling of the recharging function is achieved in that this is controlled by the user by confirming a predetermined payment amount and/or predetermined payment conditions. A predetermined payment amount of this kind can, for example, be selected from a menu with a number of different recharging amounts offered by the recharging function. The user then selects and sets one of the offered payment amounts, e.g. menu driven by display or voice control. The payment conditions can also be preset in a similar manner, with the user then, for example, being able to switch between a debit entry on one or other account or alternatively to a cash payment by a prepaid card.

The selection and setting of the payment amount and the actual payment conditions, either individually or in combination, offer the user a not insubstantial flexibility in handling recharging of the user's electronic credit for payment of the services used.

In a preferred manner, the recharging function can be modified by the user by entering a payment amount and/or payment conditions. Thus, both the payment amount and also the payment conditions can be permanently set for future bookings, e.g. from a giro account. After an account threshold value is undershot followed by a notification to recharge, the user would then only have to confirm the amount and/or payment conditions that have already been set once. A one-off setting of the payment conditions with a re-adapted payment amount, in each case, if the lower account threshold value is undershot, is of course also possible. In this case, it is also possible, depending on the set payment amount, to automatically change the lower account threshold value using the recharging function, so that for example at recharging amount greater than DM 50.00 it is DM 20.00 but at recharging amount of less than DM 50.00 it is DM 5.00.

An advantageous further aspect of the invention is also that the recharging function is performed by a voice menu and DTMF (Dual Tone Multiple Frequency) input via a keypad. A user control of this kind is then particularly useful if the user needs to regularly adapt the recharging to the user's actual needs. A trouble-free operation of the recharging function, e.g. for the driver of a vehicle, is then ensured in that operation of the recharging function is also possible by voice recognition.

It is also relatively easy to control the recharging function by entering an SMS message through the keypad. This is particularly advantageous where the user is in an environment where a voice message would be disadvantageous, e.g. in fully occupied passenger trains or open-plan offices.

In this case, it is also advantageous if the recharging function is controlled based on an IT protocol via a WAP mobile telephone and/or an Internet computer. A picture-controlled recharging function can normally be performed intuitively by a user and is self-explanatory. An Internet page of the service provider that is accessible to the user can, in this case, offer the same functionalities and possibilities as already described.

The authorization of payments, particularly if the recharging function is controlled via the Internet, is an important subject. The exchange of data should be protected by a cryptographic process, particularly during transmission in the Internet. Suitable programs such as SML (secure socket layer) or PKI (public key infrastructure) are known to the specialist, and therefore no further details of their use is given in the following.

It is advantageous if the reference account belongs to the same customer as the prepaid account to be recharged. In this case the customer would suffer no financial loss in the event that the mobile telephone is stolen or lost, because it would always be ensured that the prepaid account was always recharged from their own reference account.

A further measure of security is achieved if the time period in which the repeated recharging operation can take place is limited. This means that the method is arranged in such a way that the recharging operation is not permitted or supported until after a previously-defined time period has elapsed (for example, one day). The advantage of this would be that the rightful owner of the terminal would have sufficient time available to block the account or the mobile telephone.

Of particular note is a control service designed in the form of executable software with a service execution environment that includes the services recharged and prepaid. The prepaid service monitors the profile (prepaid credit, booked service scope) stored in a database and uses the account state of a subscriber A, that uses the prepaid services. The control service in this case ensure the smooth interaction between the service execution environment and the database.

If, for example, the current credit of subscriber A drops below a lower threshold value, a recharge service is preferably initiated by the prepaid service. This normally provides for the recharge service to be started in the service execution environment. The control service then takes over the coordination of several service execution environment parts with respect to each other and with respect to the database. The recharge service activates a recharge dialog, or a recharge menu on the display of the mobile telephone, at subscriber A on a mobile telephone used by subscriber A, shown in the top left of the illustration. Subscriber A can, for example, select and confirm a recharge amount from a number of preset amounts. At this opportunity, subscriber A can possibly, as an option, reset this preset and selected amount for a future undershoot of the threshold value and at the same time specify the payment conditions.

On conclusion of the user dialog of the recharge service, an exchange of the input data takes place at a relay point. This stores the data of the user in the service execution environment for recharging. The recharge service finally ensures the increase of the electronic credit state and the initiation, e.g. of a corresponding debit entry in a given giro account. If the user also enters a change to the lower account threshold value in the recharge dialog or menu, this is also stored by the recharge service in the database in the profile of subscriber A. In the event of a reducing credit due to the use of services by subscriber A, the prepaid service detects the re-defined lower account threshold and, in turn, initiates the recharge service if it is undershot. The maximum flexibility of the method for recharging an electronic prepaid credit is therefore available to subscriber A.

Economically-important, future applications of the invention are particularly to be seen in access, on the basis of a prepaid credit, so Internet databases using GPRS or UMTS mobile radio standards. As is known, these modern mobile radio systems enable the transmission of large amount of data at acceptable speeds, and therefore offer great potential for prepaid applications with user-friendly conditions, such as those realized by the invention. A further economically-important application is the future video-on-demand systems, i.e. in the delivery of films, video clips or other moving picture files to the holder of a prepaid credit, or also in the analog delivery of music or other audio files on the same basis.

1. A method for recharging electronic prepaid credit of a user, comprising:
setting a lower account threshold value for the credit;
signaling the undershooting of the threshold value; and
triggering a recharging function if the threshold value is undershot.

2. The method according to claim 1,
further comprising,
transmitting a signal to the user to signal the undershooting of a threshold value; and
confirming the recharging by the user after the recharge function is triggered.

3. The method according to claim 2,
wherein,
after the signal is transmitted to the user, the user receives the signal and triggers the recharging function and then the recharging function is processed.

4. The method according to claim 1,
wherein,
the recharging function is activated when the threshold value is undershot and is superimposed on a service paid for by the electronic prepaid credit currently used by the user.

5. The method according to claim 1,
wherein,
the recharging function when the threshold value is undershot is placed in a waiting state until a service paid for by the electronic prepaid credit currently being used by the user ends.

6. The method according to claim 1,
wherein,
the recharging function is also automatically repeatedly activated.

7. The method according to claim 1,
wherein,
the recharging function is not activated until after a defined time period.

8. The method according to claim 1,
wherein,
the recharging function remains active even if it is initially cancelled or ignored by the user by triggering a cancel or ignore signal.

9. The method according to claim 1,
wherein,
the recharging function increases the credit by a fixed amount.

10. The method according to claim 1,
wherein
the recharging function increases the credit by an amount that can be set by the user.

11. The method according to claim 1,
wherein,
the recharging function is triggered by the user by confirming a predetermined payment amount and/or predetermined payment condition.

12. The method according to claim 1,
wherein,
the recharging function can be modified by the user by entering a payment amount and/or payment conditions.

13. The method according to claim 1,
wherein,
the recharging function is executed via a keypad by a voice menu and DTMF input.

14. The method according to claim 1,
wherein,
the recharging function is implemented by entering a SMS message via a keypad.

15. The method according to claim 1,
wherein,
the recharging function is controlled based on an IP protocol via a WAP mobile telephone and/or an Internet computer/WAP server.

16. The method according to claim 1,
wherein,
the exchange of signals and/or data is protected by a cryptographic process.

17. The method according to claim 1,
wherein,
the recharging function can be performed by the user only within a specified time interval from a last recharging of the account.

18. The method according to claim 1,
wherein,
the recharging function accesses a reference account of the user.

19. The method according to claim 1,
wherein
the application to charge for a service, particularly a data provision service, in a GPRS or UMTS mobile radio system is based on a prepaid credit.

20. The method according to claim 1,
wherein
the application to charge for the provision of video and/or music and/or voice files in a video-on-demand system or audio-on-demand system is based on a prepaid credit.
